(19) United States
(12) Patent Application Publication
(10) Pub. No.: US 2015/0281788 A1
(43) Pub. Date: Oct. 1, 2015

(54) FUNCTION EXECUTION BASED ON DATA ENTRY

(71) Applicant: THOMSON LICENSING, Issy de Moulineaux (FR)

(72) Inventors: Juan M. NOGUEROL, Gardena, CA (US); Ben BERRY, Los Angeles, CA (US)

(21) Appl. No.: 14/671,887

(22) Filed: Mar. 27, 2015

Related U.S. Application Data
(60) Provisional application No. 61/971,105, filed on Mar. 27, 2014.

(51) Int. Cl. H04N 21/475; H04N 21/45; H04N 21/4627; H04N 21/4782

(52) U.S. Cl. CPC H04N 21/4753; H04N 21/4751; H04N 21/4782; H04N 21/4508; H04N 21/4627

(57) ABSTRACT

Executing a function of a computing system based on entering data into a data entry field of a user interface is provided. A first set of one or more characters input in the data entry field is obtained. The system determines whether the first set satisfies a non-number condition. The function can be executed based on whether or not the first set satisfies the non-number condition. A non-number condition is a condition that is not based solely on the number of characters in the set.

This application claims the benefit of U.S. Provisional Application 61/971,105, filed on Mar. 27, 2014.

### TECHNICAL FIELD

The present disclosure generally relates to digital computing systems and, more particularly, to user data entry.

### BACKGROUND

Home entertainment systems, including television and media centers, are converging with the Internet and providing access to a large number of available sources of content, such as video, movies, TV programs, music, etc. This expansion in the number of available sources necessitates a new strategy for navigating a media interface associated with such systems and enabling access to certain portions of media content being consumed by the user.

With this expansion, there is a trend towards providing personalized content to a user who has set up a profile including personal information. The personal information may describe the user, as well as their interests. Additionally, this personal information may also provide information about content sources available to the particular user. These content sources may be one of a local content source (e.g. on a local area network in a media storage repository) and a third party content source (e.g. subscription based service or pay per view system). Often times, access to these systems are kept private and require a user to log in with various user credentials. To accomplish this, the user must enter a plurality of information into data entry fields which are then stored and used at a later time to re-access the system. However, the process associated with entering user data is time consuming and requires continuous action from a user to advance to subsequent data entry fields for entry of additional data. This problem is exacerbated when a user entering the data is using an input device that does not have a full array of keys for input of different types of information. This requires the user to enter data in an unfamiliar way and may result in either the incorrect entry of information and/or incomplete entry of information by inadvertently advancing to a subsequent data entry field prior to completing the entry of data. Typically, a user has to enter in a command to advance from a first field to a second field. Alternatively, systems exist that perform an “auto-complete” function as used for text messaging or for search engines where, based on the entry of a few characters, the system automatically analyzes the input and provides a suggestion of the full input before the input is complete. A problem associated with this type of system is that the auto-complete feature may select an incorrect word thereby resulting in erroneous data being entered into the field and denying a user access to the desired system.

### SUMMARY

In various embodiments, a function of a computing system can be executed based on whether data input in a data entry field, e.g. a set of one or more characters, satisfies a non-number condition. A non-number condition is a condition that is not based solely on the number of characters in the set. For example, a first set of one or more characters input in a data entry field can be obtained. A first determination, including a determination of whether the first set satisfies a non-number condition, can be obtained. The function of the computing system can be executed based on the first determination if the first set satisfies the non-number condition. The function is not executed based on the first determination if the first set does not satisfy the non-number condition.

### BRIEF DESCRIPTION OF THE DRAWINGS

These and other aspects, features and advantages of the present disclosure will be described or become apparent from the following detailed description of various example embodiments, which is to be read in connection with the accompanying drawings.

In the drawings, wherein like reference numerals denote similar elements throughout the views:

FIG. 1 is a block diagram of an example system for delivering video content in accordance with the present disclosure;

FIG. 2 is a block diagram of an example set-top box/digital video recorder (DVR) in accordance with the present disclosure;

FIG. 3A is an example tablet and/or second screen device in accordance with an embodiment of the present disclosure;

FIG. 3B is an example remote controller in accordance with an embodiment of the present disclosure;

FIG. 4 is a flowchart illustrating an example method of executing a function of a computing system according to various embodiments.

FIG. 5 illustrates one specific example application of the example method of FIG. 4.

FIG. 6 is a flowchart illustrating another example method of executing a function of a computing system according to various embodiments.

FIGS. 7A-D illustrate one specific example application of the example method of FIG. 6.

FIG. 8 illustrates an example format of a data entry field in accordance with an embodiment of the present disclosure;

FIG. 9 is a block diagram of an example field processor in accordance with an embodiment of the present disclosure;

FIGS. 10A & 10B are example graphical user interface (GUI) display images generated in accordance with an embodiment of the present disclosure;

FIG. 11 is flow diagram including an example algorithm in accordance with an embodiment of the present disclosure; and

FIG. 12 is a flow diagram detailing another example algorithm in accordance with an embodiment of the present disclosure.

It should be understood that the drawings are for purposes of illustrating the concepts of the disclosure and are not necessarily the only possible configurations for illustrating the disclosure.

### DETAILED DESCRIPTION

It should be understood that the elements shown in the figures may be implemented in various forms of hardware, software or combinations thereof. These elements may be implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within the scope of the disclosure.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

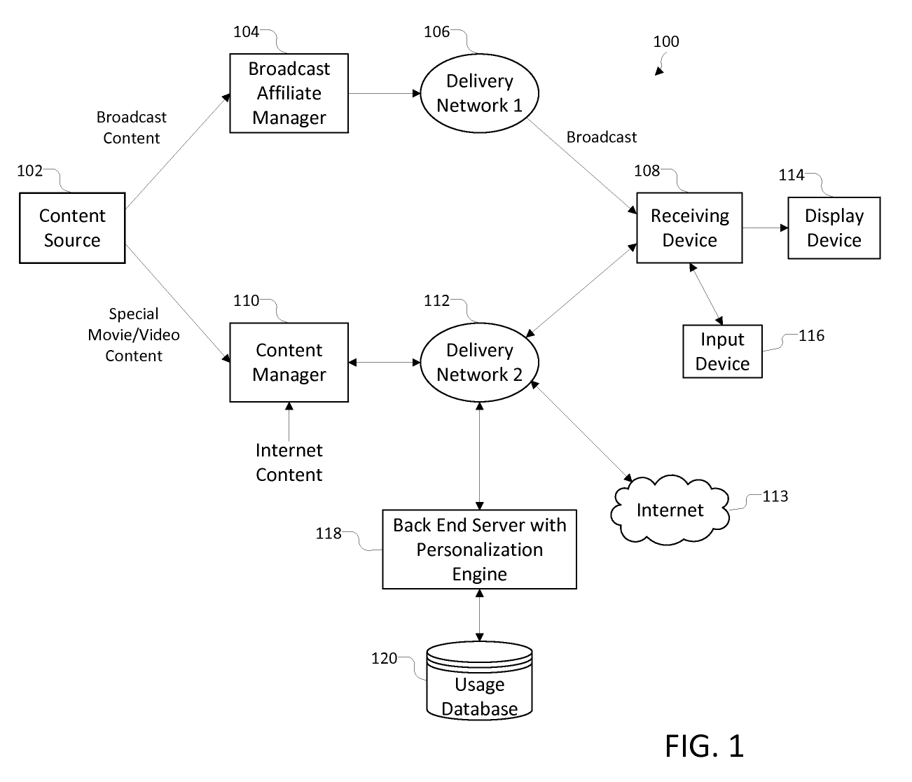

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a delivery network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include premium viewing content, pay-per-view content, Internet access, other content otherwise not provided to the broadcast affiliate manager, e.g., movies, video games, other video elements, etc. The special content may be content requested by the user, such as a webpage, a movie download, etc. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In some embodiments, the user may obtain content, such as webpages, etc., directly from the Internet 113 via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

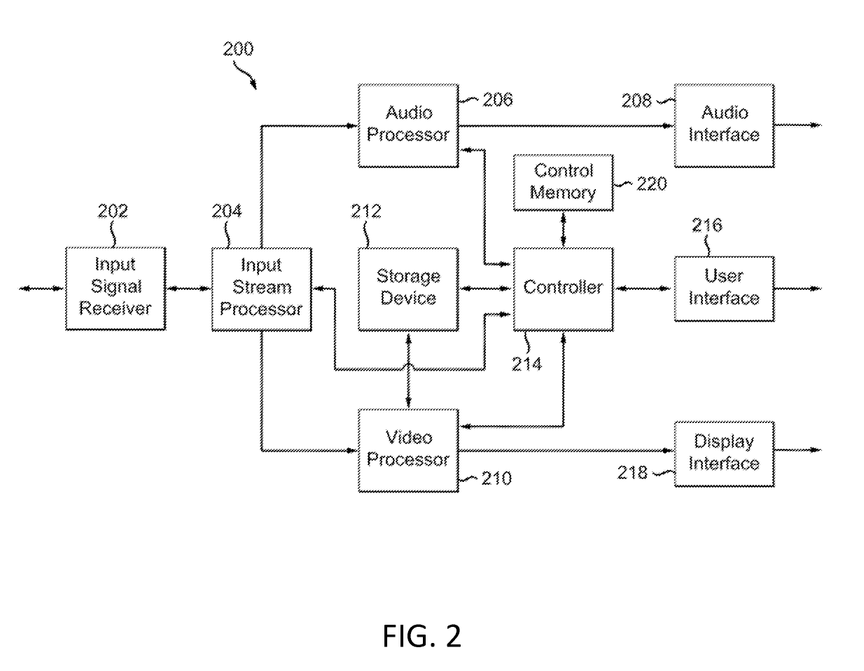

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. In some embodiments, display device 114 can be an external display coupled to receiving device 108. In some embodiments, receiving device 108 and display device 114 can be parts of a single device. The display device 114 may be, for example, a conventional 2-D type display, an advanced 3-D display, etc.

The receiving device 108 may also be coupled to an input device 116, such as a remote controller, a keyboard, a mouse, a touch panel, a touch screen, etc. The input device 116 may be adapted to provide user control for the receiving device 108 and/or the display device 114. In some embodiments, input device 116 may be an external device that can couple to receiving device 108 via, for example, a wired connection, a signal transmission system, such as infra-red (IR), radio frequency (RF) communications, etc., and may include standard protocols such as universal serial bus (USB), infra-red data association (IRDA) standard, Wi-Fi, Bluetooth and the like, proprietary protocols, etc. In some embodiments, receiving device 108 and input device 116 can be part of the same device. Operations of input device 116 will be described in further detail below.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118. In the present example, the back end server 118 (as well as the usage database 120) is connected to the system 100 and accessed through the delivery network 2 (112). In other embodiments, the usage database 120 and backend server 118 may be embodied in the receiving device 108. In other embodiments, the usage database 120 and back end server 118 may be embodied on a local area network to which the receiving device 108 is connected.

FIG. 2 includes a block diagram of an example computing system, such as a receiving device 200. Receiving device 200 may operate similar to the receiving device described in FIG. 1 and may be included as part of a gateway device, modem, set-top box, personal computer, tablet computer, smartphone, etc. The device 200 shown may also be incorporated into other systems including an audio device or a display device. The receiving device 200 may be, for example, a set top box coupled to an external display device (e.g., a television), a personal computer coupled to a display device (e.g., a computer monitor), etc. In some embodiments, the receiving device 200 may include an integrated display device, for example, a portable device such as a tablet computer, a smartphone, etc.

In the device 200 shown in FIG. 2, the content is received by an input signal receiver 202. The input signal receiver 202 may include, for example, receiver circuits used for receiving, demodulation, and decoding signals provided over one of the several possible networks including over the air, cable, satellite, Ethernet, fiber and phone line networks. The desired input signal may be obtained based on user input provided through a user interface 216. For example, the user input may include search terms for a search, and the input signal received by input signal receiver 202 may include search results. User interface 216 can be coupled to an input device, such as input device 116, and can receive and process corresponding user inputs, for example, keystrokes, button presses, touch inputs, such as gestures, audio input, such as voice input, etc., from the input device. User interface 216 may be adapted to interface to a cellular phone, a tablet, a mouse, a high end remote, etc.

The decoded output signal is provided to an input stream processor 204. The input stream processor 204 performs the final signal selection and processing, and includes separation of video content from audio content for the content stream. The audio content is provided to an audio processor 206 for conversion from the received format, such as a compressed digital signal, to an analog waveform signal. The analog waveform signal is provided to an audio interface 208 and further to the display device or audio amplifier. In some embodiments, the audio interface 208 may provide a digital signal to an audio output device or display device using a High-Definition Multimedia Interface (HDMI) cable, an audio interface such as via a Sony/Philips Digital Interconnect Format (SPDIF), etc. The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (RW), received from user interface 216. The storage device 212 may be, for example, a hard disk drive, one or more large capacity integrated electronic memories, such as static RAM (SRAM), or dynamic RAM (DRAM), an interchangeable optical disk storage system such as a compact disk (CD) drive or digital video disk (DVD) drive, etc.

The converted video signal, from the video processor 210, either originating from the input or from the storage device 212, is provided to the display interface 218. The display interface 218 further provides the display signal to a display device, such as display device 114, described above. The display interface 218 may be, for example, an analog signal interface such as red-green-blue (RGB), a digital interface such as HDMI, etc. In some embodiments, display interface 218 may, for example, generate various screens for presenting search results obtained based on user input (e.g., in a three dimensional grid, two dimensional array, and/or a shelf as will be described in more detail below). In some embodiments, a screen of search results may be obtained, for example from the Internet, and display interface 218 may simply provide the display device with the obtained screen.

The controller 214 is interconnected via a bus to several of the components of the device 200, including the input stream processor 204, audio processor 206, video processor 210, storage device 212, and user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the grid, array and/or shelf display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory 220 may also store a database of elements, such as graphic elements containing content. The database may be stored as a pattern of graphic elements, such as graphic elements containing content, various graphic elements used for generating a displayable user interface for display interface 218, and the like. In some embodiments, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device, more than one memory circuit communicatively connected or coupled together to form a shared or common memory, etc. Still further, the memory may be included with other circuitry, such as portions of bus communications circuitry, in a larger circuit.

Optionally, controller 214 can be adapted to extract metadata, criteria, characteristics or the like from audio and video media by using audio processor 206 and video processor 210, respectively. That is, metadata, criteria, characteristics or the like that is contained in the vertical blanking interval, auxiliary data fields associated with video, or in other areas in the video signal can be harvested by using the video processor 210 with controller 214 to generate metadata that can be used for functions such as generating an electronic program guide having descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, provide security which identifies the source of an audio signal, or perform some other service. Furthermore, metadata, criteria, characteristics or the like, to support the actions listed above can come from a network source which are processed by controller 214.

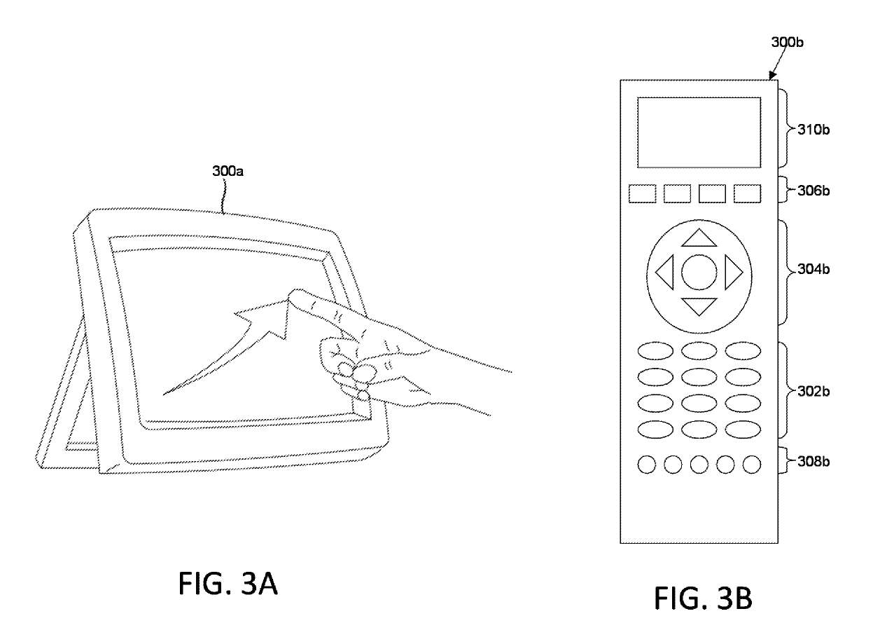

FIGS. 3A and 3B represent two example input devices, 300a and 300b (hereinafter referred to collectively as input device 300), such as input device 116. Input device 300 can couple with a user interface, such as user interface 216. Input device 300 may be used to initiate and/or select various functions available to a user related to the acquisition, consumption, access and/or modification of content, such as multimedia content, broadcast content, Internet content, etc. FIG. 3A illustrates an example touch panel input device 300a. The touch panel device 300a may be interfaced, for example, via the user interface 216 of the receiving device 200 in FIG. 2. The touch panel device 300a allows operation of the receiving device or set top box based on hand movements, or gestures, and actions translated through the panel into commands for the set top box or other control device. This is achieved by the controller 214 generating a touch screen user interface including at least one user selectable image element enabling initiation of at least one operational command. The touch screen user interface may be pushed to the touch screen device 300a via the user interface 216. In some embodiments, the touch screen user interface generated by the controller 214 may be accessible via a webserver executing on one of the user interface 216. The touch panel 300a may serve as a navigational tool to navigate a grid display, as described above for search results. In some embodiments, the touch panel 300a may serve as a display device allowing the user to more directly interact with the navigation through the grid display of content. The touch panel 300a can also include a camera element and/or at least one audio sensing element.

In some embodiments, the touch panel 300a employs a gesture sensing controller or touch screen enabling a number of different types of user interaction. The inputs from the controller are used to define gestures and the gestures, in turn, define specific contextual commands. The configuration of the sensors may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motions, such as a swing. Gestures are interpreted in context and are identified by defined movements made by the user. Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be placed in a different spot and used for channel up/down. In this way specific gesture mappings may be used. For example, the touch screen device 300a may recognize alphanumeric input traces which may be automatically converted into alphanumeric text displayable on one of the touch screen device 300a or output via display interface 218 to a primary display device.

FIG. 3B illustrates another example input device, input device 300b. The input device 300b may, for example, be used to interact with the user interfaces generated by the system and which are output for display by the display interface 218 to a primary display device (e.g. television, monitor, etc). The input device of FIG. 3B may be formed as a remote control having a 12-button alphanumerical key pad 302b and a navigation section 304b including directional navigation buttons and a selector button. The input device 300b may also include a set of function buttons 306b that, when selected, initiate a particular system function (e.g. menu, guide, DVR, etc). In some embodiments, the input device 300b may include a set of programmable application specific buttons 308b that, when selected, may initiate a particularly defined function associated with a particular application executed by the controller 214. The depiction of the input device in FIG. 3B is merely exemplary and the input device may include any number and/or arrangement of buttons that enable a user to interact with the user interface process according to various embodiments. Additionally, it should be noted that users may use either or both of the input devices depicted and described in FIGS. 3A and 3B simultaneously and/or sequentially to interact with the system.

In some embodiments, the user input device may include at least one of an audio sensor and a visual sensor. For example, the audio sensor may sense audible commands issued from a user and translate the audible commands into functions to be executed by the user. The visual sensor may sense the user's presence and match user information of the sensed user(s) to stored visual data in the usage database 120 in FIG. 1. Matching visual data sensed by the visual sensor enables the system to automatically recognize the user's presence and retrieve any user profile information associated with the user. Additionally, the visual sensor may sense physical movements of at least one user present and translate those movements into control commands for controlling the operation of the system. In this embodiment, the system may have a set of pre-stored command gestures that, if sensed, enable the controller 214 to execute a particular feature or function of the system. An example type of gesture command may include the user waving their hand in a rightward direction which may initiate a fast forward command or a next screen command or a leftward direction which may initiate a rewind or previous screen command depending on the current context. This description of physical gestures able to be recognized by the system is merely exemplary and should not be taken as limiting. Rather, this description is intended to illustrate the general concept of physical gesture control that may be recognized by the system and persons skilled in the art could readily understand that the controller may be programmed to specifically recognize any physical gesture and allow that gesture to be tied to at least one executable function of the system.

According to various embodiments, the present system can obtain characters entered into a data entry field and can determine whether the characters satisfy a condition. If the characters satisfy the condition, a function can be executed.

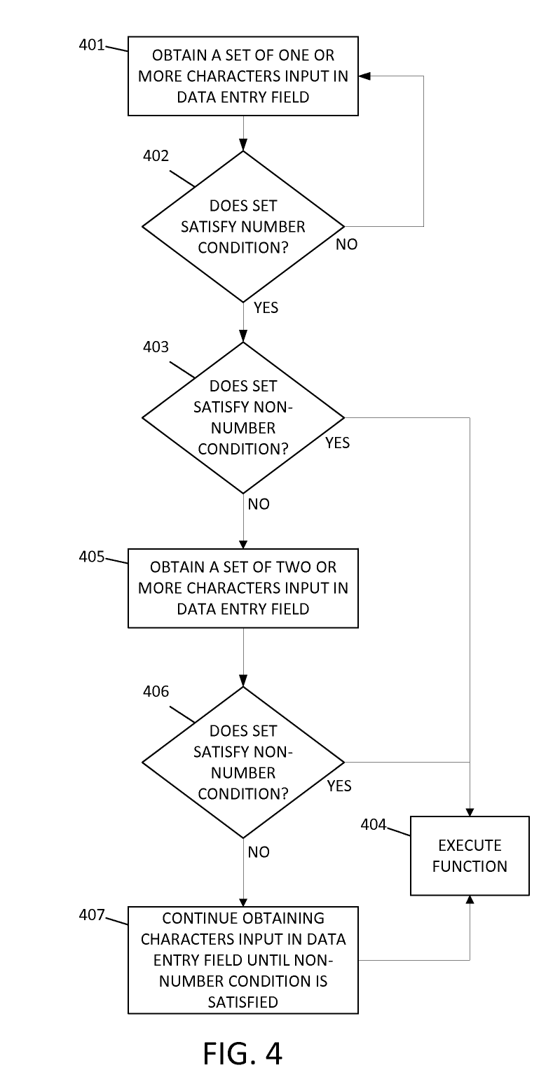

FIGS. 4, 5, 6, 7A-D, 11, and 12 include flowcharts illustrating example methods according to various embodiments. The example methods may be implemented by, for example, by a computing system such as a general purpose computer through computer-executable instructions (e.g., software, firmware, etc.) stored on a computer-readable medium (e.g., storage disk, memory, etc.) and executed by a computer processor. Referring to FIG. 2, for example, software implementing one or more example methods shown in the flowcharts could be stored in storage device 212 and executed by controller 214.

FIG. 4 is a flowchart illustrating an example method of executing a function of a computing system according to various embodiments. In this example method, a set of one or more characters input in a data entry field can be obtained (401). For example, when a user inputs a first character in the data entry field, the set obtained by the system can be the first character. The system can determine (402) whether the set satisfies a number condition, i.e., a condition that is based solely on the number of characters in the set. For example, the number condition can be the number of characters in the set is greater than or equal to a predetermined number. In some embodiments, the number condition can be, for example, the number of characters in the set is less than or equal to a predetermined number, the number of characters in the set is equal to a predetermined maximum number of characters of the data entry field, etc. In some embodiments, the number condition can be the number of characters in the set is at least one; in other words, the first character input in the data entry field can satisfy the number condition. In this case, for example, the system need not determine whether the set satisfies a number condition, but merely determine that a character has been input in the data entry field.

If the system determines (402) the set does not satisfy the number condition, the process can return to 401 to obtain a next set of characters in response to an additional character being input in the data entry field. On the other hand, if the system determines (402) the set satisfies the number condition, the system can determine (403) whether the set satisfies a non-number condition, i.e., a condition that is not based solely on the number of characters in the set. In some embodiments, a non-number condition can include whether the set matches a predetermined combination of characters. For example, the predetermined combination of characters can include a password, a user name, etc. In some embodiments, a non-number condition can include whether the set matches any one of multiple predetermined combinations of characters. For example, the multiple predetermined combinations of characters can include a list of names, a list of popular words, a list of all known words, a list of phrases, a list of favorite search words, etc.

If the system determines (403) the set satisfies the non-number condition, the system can execute (404) a function. Example functions will be described in more detail below. On the other hand, if the system determines (403) the set does not satisfy the non-number condition, the system can obtain (405) a set of two or more characters in response to an additional character being input in the data entry field. The system can determine (406) whether the set of two or more characters satisfies the non-number condition and, if so, can execute (404) the function. Otherwise, the system can repeat (407) the process of obtaining sets of characters as additional characters are input in the data entry field, determining whether the non-number condition is satisfied, and can execute (404) the function when, and if, the non-number condition is satisfied.

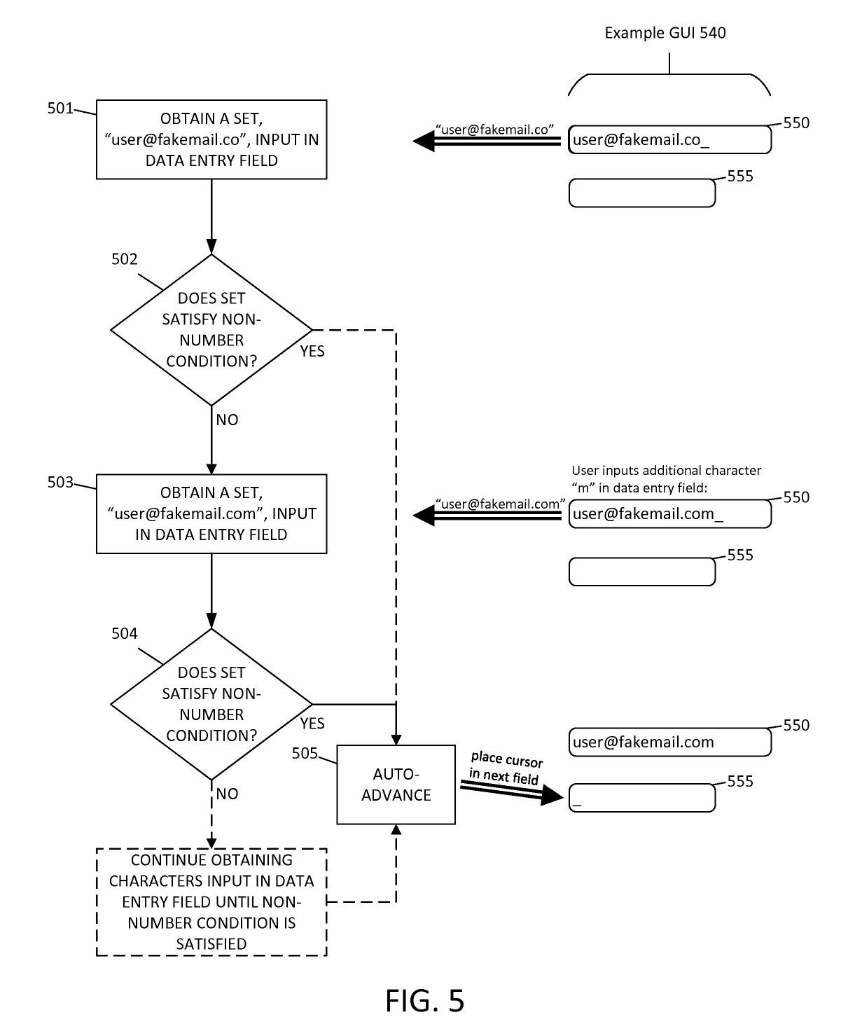

In the example illustrated in FIG. 4, the method may be complete for the particular data entry field once the function is executed. In other words, FIG. 4 illustrates an example embodiment that may be suitable when a function is to be executed only once for a data entry field. In some embodiments, the function can include logging in to a user account, for example, when the system determines the set of characters entered into a password field satisfies a non-number condition of matching the user's password. In this case, upon determining an obtained set of characters matches the password, the function of logging in is executed, and no more characters are accepted in the password field (e.g., the password field may disappear, replaced with a screen of the logged-in user account). FIG. 5 illustrates another example method according to various embodiments, in which a function may be executed only once for a data entry field.

FIG. 5 illustrates one specific example application of the example method of FIG. 4. FIG. 5 illustrates an example method of automatically advancing to a next data entry field. FIG. 5 includes a flowchart and also includes illustrations of various stages of example user input in an example GUI 540, which includes a data entry field 550 and a next data entry field 555. In this example embodiment, data entry field 550 is an email field, and next data entry field 555 can be a password field, for example. The various stages of user input are positioned next to points in the flowchart corresponding to input (e.g., obtaining set of characters) and output (e.g., auto-advancing) to show how GUI 540 may appear at various points during the method. Because the purpose of FIG. 5 is to illustrate one specific example application of the method of FIG. 4, and the flowchart of FIG. 5 is directed to example user input, the flowchart shows that some paths are not used and that some actions are not performed. For the purpose of illustration, the unused paths and unperformed actions are shown with dashed lines in the flowchart.

FIG. 5 shows a portion of an example method after the user has input “user@fakemail.co” in data entry field 550. The system obtains (501) the set of characters, “user@fakemail.co”, and determines (502) whether the set satisfies a non-number condition. In this example, the non-number condition is: the last characters in the set match an email domain from a predetermined list of email domains (e.g., .com, .edu, .org, .us, . . . ). In this example, the system determines (502) that the last characters of “user@fakemail.co” do not match an email domain from the predetermined list; therefore, the system obtains (503) the set, “user@fakemail.com”, after the user inputs the additional character “m” in data entry field 550. The system determines (504) that the set, “user@fakemail.com”, satisfies the non-number condition because the last characters match “.com” from the predetermined list of email domains. In response, the system auto-advances (505) by moving the cursor from data entry field 550 to next data entry field 555.

While FIG. 5 shows only the portion of a process beginning after the user has already input multiple characters (“user@fakemail.co”) in data entry field 550 for the sake of clarity and brevity, one skilled in the art should readily understand that similar processes can be applied for the previous characters, i.e., first character input, “u”, the second character input, “s”, the third character input, “e”, etc. For example, the process for these characters can include obtaining the set of characters in data entry field 550 after each character is input, and determining whether the set satisfies the non-number condition. Some embodiments can further include determination of a number condition similar to the example embodiment illustrated in FIG. 4.

While the example embodiments illustrated by FIGS. 4 and 5 may be suitable when a function is to be executed only once for a data entry field, it should be readily understood that, in various embodiments, the methods can be applied to more than one data entry field. For example, after auto-advancing is executed (505) in FIG. 5, a similar method can be used for executing a function based on character input in next data entry field 555.

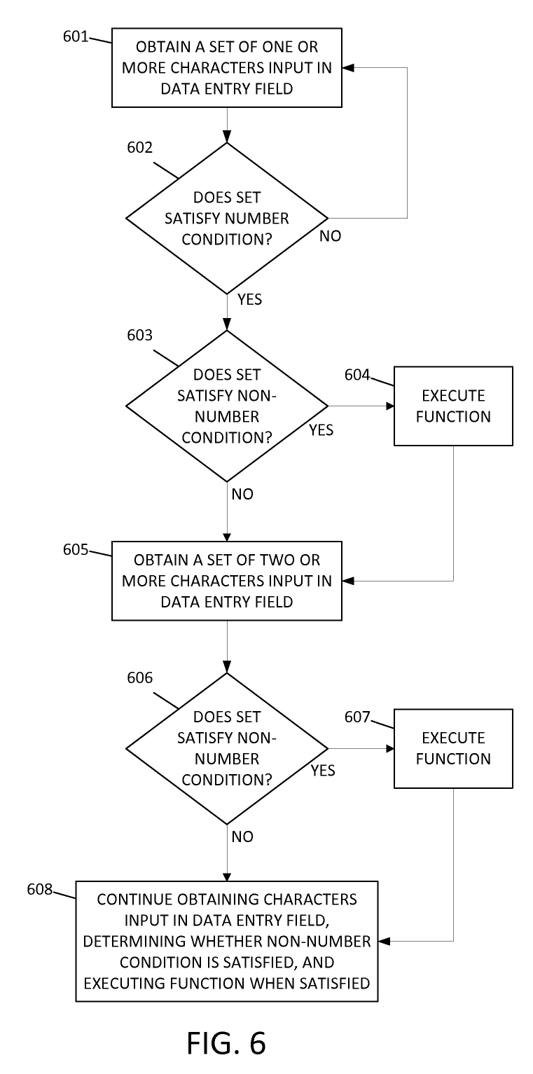

FIG. 6 is a flowchart illustrating another example method of executing a function of a computing system according to various embodiments. In this example method, a set of one or more characters input in a data entry field can be obtained (601). For example, when a user inputs a first character in the data entry field, the set obtained by the system can be the first character. The system can determine (602) whether the set satisfies a number condition. If the system determines (602) the set does not satisfy the number condition, the process can return to 601 to obtain a next set of characters in response to an additional character being input in the data entry field. On the other hand, if the system determines (602) the set satisfies the number condition, the system can determine (603) whether the set satisfies a non-number condition.

If the system determines (603) the set satisfies the non-number condition, the system can execute (604) a function, and the process can proceed to 605. On the other hand, if the system determines (603) the set does not satisfy the non-number condition, the process can proceed to 605 without executing the function. The system can obtain (605) a set of two or more characters in response to an additional character being input in the data entry field. The system can determine (606) whether the set of two or more characters satisfies the non-number condition and, if so, can execute (607) the function, and the process can proceed to 608. On the other hand, if the system determines (606) the set does not satisfy the non-number condition, the process can proceed to 608 without executing the function. The system can repeat (608) the process of obtaining sets of characters as additional characters are input in the data entry field, determining whether the non-number condition is satisfied, and executing the function each time the system determines that the set satisfies the non-number condition.

In the example illustrated in FIG. 6, the method may continue to obtain sets of characters and to execute the function when the obtained set satisfies the non-number condition. In other words, FIG. 6 illustrates an example embodiment that may be suitable when a function may be executed multiple times during data input in a data entry field. In some embodiments, for example, the function can include performing a search when the system determines the set of characters entered into a search field satisfies a non-number condition of matching one or more words from a predetermined list of search terms. In this case, upon determining an obtained set of characters matches one or more of the predetermined search terms, the system can execute a function of searching and providing/updating search results, and a user can continue to input characters in the search field, which can result in additional searches and updating of search results as additional characters are added to the search field. For example, additional characters may modify a previously-searched word to create another matching search term (e.g., the system may obtain the set “foot”, perform a search using the search term “foot”, and provide the search results, and then the user may add the additional characters “ball” to form “football”, and the system can perform another search using the search term “football”, and update the search results). In another example, additional characters may add an additional search term (e.g., the system may obtain the set “foot”, perform a search using the search term “foot”, and provide the search results, and then the user may press the spacebar and then add the additional characters “doctor” to form “foot doctor”, and the system can perform another search using the search terms “foot” and “doctor”, and update the search results).

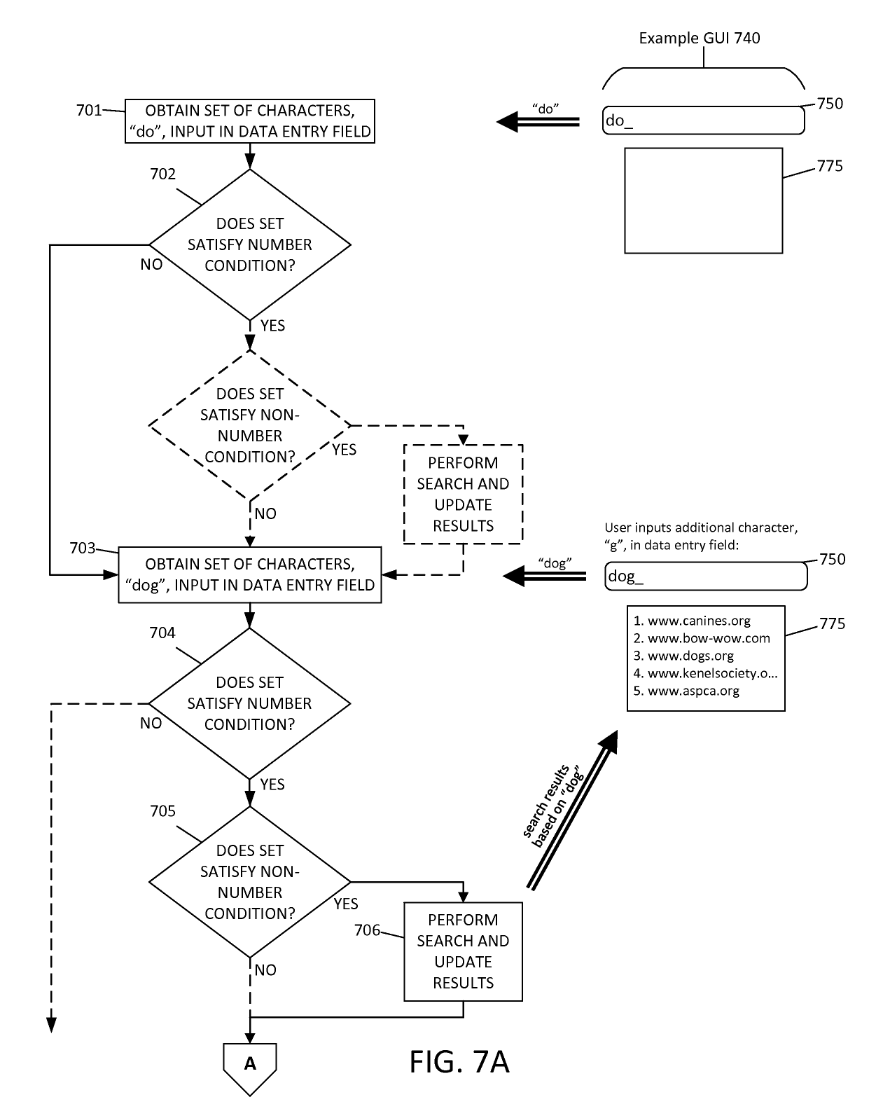

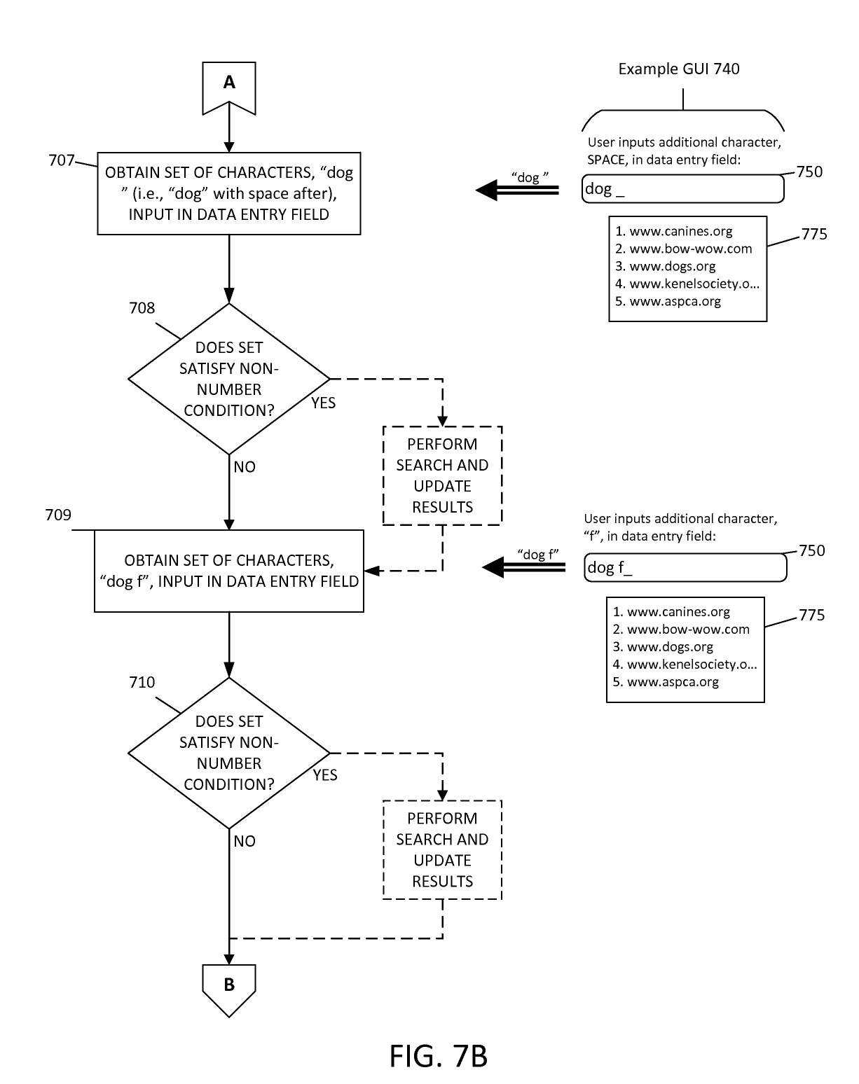

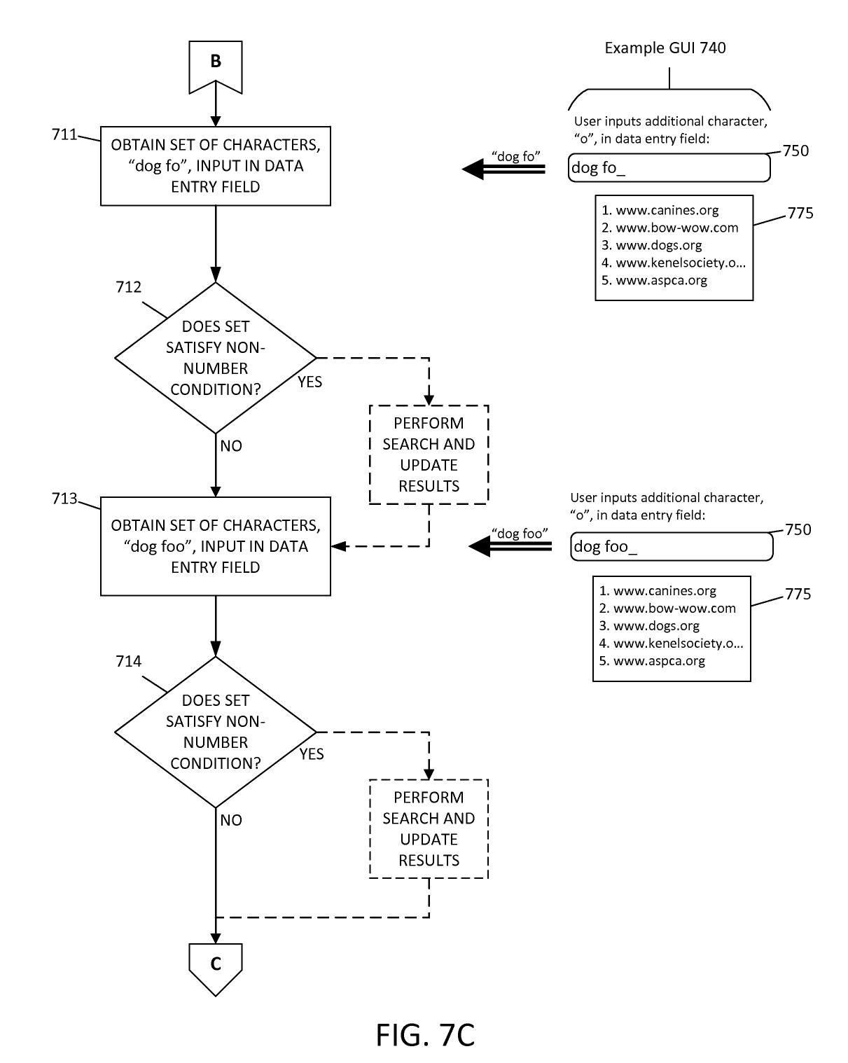

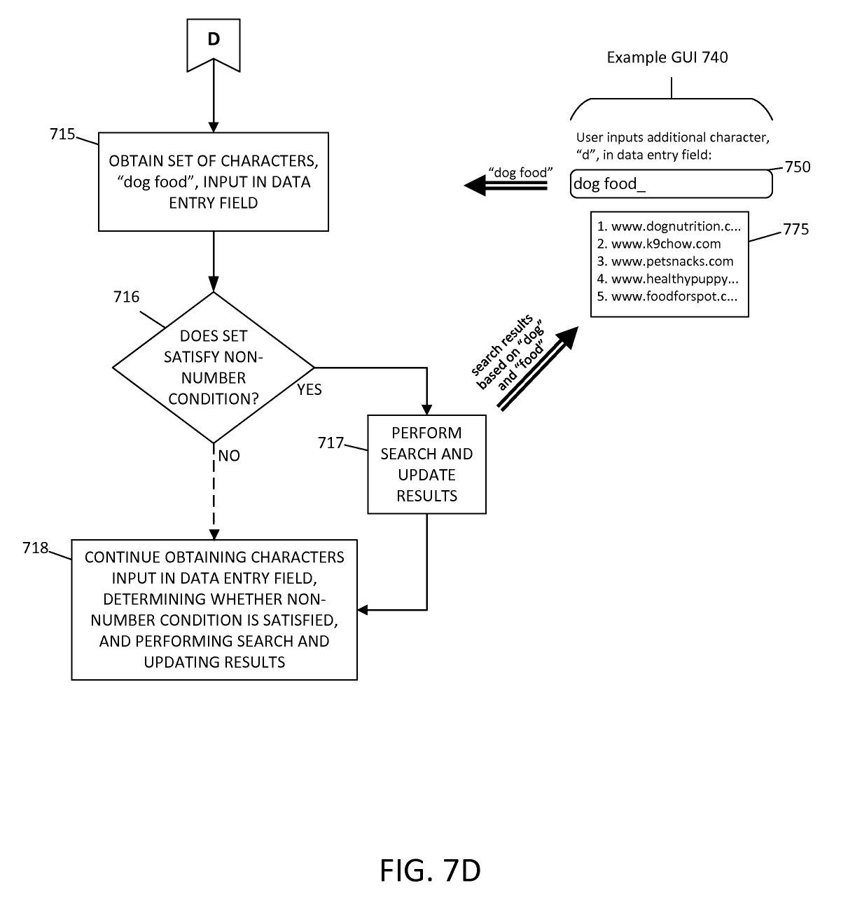

FIGS. 7A-D illustrate another example method according to various embodiments, in which a function may be executed multiple times during data input in a data entry field.

FIGS. 7A-D illustrate one specific example application of the example method of FIG. 6. FIGS. 7A-D illustrate an example method of automatically executing an Internet search and update of Internet search results. FIGS. 7A-D include a flowchart and also include illustrations of various stages of example user input in an example GUI 740, which includes a data entry field 750, which can be an Internet search field, and an Internet search results area 755. The various stages of user input are positioned next to points in the flowchart corresponding to input (e.g., obtaining set of characters) and output (e.g., searching and updating search results) to show how GUI 740 may appear at various points during the method. Because the purpose of FIGS. 7A-D is to illustrate one specific example application of the method of FIG. 6, and the flowchart of FIGS. 7A-D is directed to example user input, the flowchart shows that some paths are not used and that some actions are not performed. For the purpose of illustration, the unused paths and unperformed actions are shown with dashed lines in the flowchart.

FIGS. 7A-D show a portion of an example method after the user has input “do” in data entry field 750. The system obtains (701) the set of characters, “do”, and determines (702) whether the set satisfies a number condition. In this example, the number condition is: the number of characters in the set is greater than two. The system determines (702) that the set does not satisfy the number condition, and the process proceeds to 703. The system obtains (703) the set, “dog”, after the user inputs the additional character “g” in data entry field 750. The system determines (704) that the set satisfies the number condition, and determines (705) whether the set satisfies a non-number condition. In this example, the non-number condition is: the set of characters match one search term from a predetermined list of search terms or match a combination of multiple search terms from the list, where a space can indicate a separation between groups of characters in the data entry field into multiple potential search term matches. In this example, the system determines (705) that the set satisfies the non-number condition because, for example, “dog” is a search term on the predetermined list; therefore, the system executes (706) an Internet search and results update by performing an Internet search using the search term “dog” and updating Internet search results area 775 to display results of the search, as shown in FIG. 7A. The process then proceeds to 707 (see, FIG. 7B).

The system obtains (707) the set, “dog ” (i.e., “dog” with a space after), after the user inputs a space in data entry field 750. The system determines (708) that the set does not satisfy the non-number condition because, for example, the space signifies a separate potential search term match following “dog”, and there are no characters after the space that match a predetermined search term. In this case, the Internet search results displayed in Internet search result area 775 may remain unchanged, and the process proceeds to 709. The system obtains (709) the set, “dog f”, after the user inputs the additional character “f” in data entry field 750. The system determines (710) that the set does not satisfy the non-number condition because, for example, the group of characters (i.e., the single character “f”) after the space does not match a predetermined search term. In this case, the Internet search results displayed in Internet search result area 775 may remain unchanged, and the process proceeds to 711 (see FIG. 7C).

The system obtains (711) the set, “dog fo”, after the user inputs the additional character “o” in data entry field 750. The system determines (712) that the set does not satisfy the non-number condition because, for example, the group of characters (i.e., “fo”) after the space does not match a predetermined search term. In this case, the Internet search results displayed in Internet search result area 775 may remain unchanged, and the process proceeds to 713. The system obtains (713) the set, “dog foo”, after the user inputs the additional character “o” in data entry field 750. The system determines (714) that the set does not satisfy the non-number condition because, for example, the group of characters (i.e., “foo”) after the space does not match a predetermined search term. In this case, the Internet search results displayed in Internet search result area 775 may remain unchanged, and the process proceeds to 715 (see FIG. 7D).

The system obtains (715) the set, “dog food”, after the user inputs the additional character “d” in data entry field 750. The system determines (716) that the set satisfies the non-number condition because, for example, “dog” is a search term on the predetermined list and “food” is a search term on the predetermined list; therefore, the system executes (717) an Internet search and results update by performing an Internet search using the search terms “dog” and “food” and updating Internet search results area 775 to display results of the search, as shown in FIG. 7D. The system can continue (718) obtaining characters input in data entry field 750, determining whether obtained sets satisfy the non-number condition, and performing searches and updating results and the user continues to add characters to and/or delete characters from data entry field 750.

In some embodiments, the method may continue until a stop condition is met. A stop condition could include, for example, the number of times the function is executed has reached a predetermined limit, a predetermined user input is received (e.g., a “tab” key press, a “return” key press, a mouse click in another data entry field, etc.), etc. It should be noted that the example processes of FIG. 6, 7, and other example embodiments disclosed herein, can include, for example, periodically checking for a stop condition, as one skilled in the art would readily understand.

As described above, some embodiments can include generating GUI display images including one or more data entry fields, and in some embodiments, a function to be executed can include automatically advancing from one data entry field to a next (or subsequent data entry field) when the system determines that characters entered into the data entry field by a user satisfy a condition. The data entry fields included in the GUI display image can enable users to selectively input characters into a data entry field and, in response to determining that the entered characters satisfy at least one condition, automatically advances to a subsequent (or next) data entry field to allow for further input of different data. The automatic advancement to subsequent data entry fields can occur without needing to receive a designated “advance” or “enter” (e.g. selecting a “next” button positioned adjacent to a particular data entry field to submit the data to the system for processing) command from the user. By automatically sensing that the entered characters satisfy a condition and advancing the data input to subsequent data entry fields, the present system may improve the user experience associated with entering data. Moreover, in some embodiments, a user entering data in one data entry field can be prevented from accessing any further data entry fields until the at least one condition associated with that data entry field has been satisfied. In this way, for example, security may be improved in some systems.

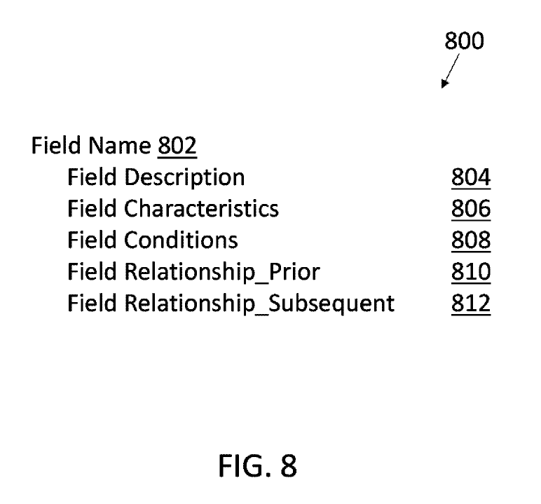

In various embodiments, implementation can include associating each data entry field with a plurality of information. The field information can provide information about the field to an executable application that selects the field for inclusion into a user interface as well as any processors that process data that is entered into the data entry field by a user. FIG. 8 is a representation of example field information 800 of a data entry field according to various embodiments. In particular, FIG. 8 illustrates one type of example field structure including example field information 800. Persons skilled in the art may readily expand and/or restructure the field based on the principles described herein. Moreover, while field information 800 for only a single data entry field is shown herein, it should be understood that systems according to various embodiments can include a plurality of data entry fields that may each be associated with respective field conditions, such as number conditions and/or non-number conditions, that can be used to execute one or more various functions.

Information associated with field information 800 may be stored in a repository such as a database and be selectively accessible by various processors and modules that execute instructions for generating and displaying a UI including at least one data entry field. FIG. 8 illustrates field information 800 in an example field record for a particular data entry field that may be stored in a repository and used in accordance with various embodiments. Field information 800 can include a “field name” 802 that may serve as an identifier used by an executable application that controls UI generation. It may, for example, be a reference indicator, used by the UI generator that can look up and acquire the associated data entry field and all associated information for presentation to a user in a user interface. Additionally, the field information may include “field description” data 804 that describes at least one type of information about the data entry field. For example, this may include a description representing a type of information that is to be acquired when a user inputs data into the data entry field. In one embodiment, “field description” data 804 may be presented within the UI along with portions of the actual field information 800 thereby providing a user who is entering data into the date entry field with instructions for the type of data to input and/or the manner in which the data is to be input into the date entry field. For example, if the data entry field is a date field that requires the user to enter data in the form of a date, field information 800 may include instructions such as “Enter date (MM/DD/YYYY)”. This instructs the user to enter a date in the format indicated. The field information 800 may also include “field characteristic” data 806 that describes at least one characteristic associated with the data to be entered therein. The at least one characteristic may include, but is not limited to, any of a required number of characters to be entered, a minimum number of characters to be entered, a maximum number of characters to be entered, a type of character to be entered (e.g. number, letter, symbol, etc), and field length. These characteristics are provided for purposes of example only and the field characteristic data may include anything that describes any aspect of the field with which it is associated.

The field information 800 can also include field condition data 808. Field condition data 808 represents data corresponding to one or more number conditions and/or one or more non-number conditions. Thus, field condition data 808 can provide the rules for governing the execution of a function based on data entry in the associated data entry field, for example, automatic advancement to a subsequent (or a next) data entry field. Field condition data 808 may be, for example, information that may be used as a point of comparison with the data being actively entered into the data entry field by the user. In some embodiments, the field condition data 808 may include formatting data that requires data be entered in a predetermined format using at least one of a predetermined number of characters and predetermined type of characters. In some embodiments, field condition data 808 may include, but is not limited to, at least one of a predetermined number of alphanumeric characters, a predetermined type of data, a type of data selected from a candidate set of types of data, a type of data associated with a user profile, a predetermined order of alphanumeric characters, a combination of a predetermined type of alphanumeric characters and symbol characters, and data describing a characteristic of a user. The system automatically validates the entered data in response to detecting a completed entry to determine if the field condition data 808 based on formatting information has been satisfied. Validation can include determining that at least a portion of the data entered by the user in the data entry field matches the field condition data. Upon validation, the system can execute a function, such as automatically advancing a visual indicator (e.g., a cursor) to a subsequent data entry field indicating data can now be entered into the subsequent data entry field because the prior field conditions have been satisfied. In some embodiments, field condition data 808 can advantageously improve the speed and navigability of a UI system that is charged with acquiring information from a user by automatically advancing from a first field to a second subsequent field when the system determines the previously input data by the user has been entered in the desired manner. In some embodiments, a particular data entry field may include more that one field condition data associated therewith requiring the satisfaction of two or more different conditions prior to validating that the data input is the desired type of data for the particular data entry field. For example, a data entry field may require a specific number of characters input by a user (e.g., a number condition) and also require that the last four characters input be of a certain type (e.g., a non-number condition). For example, as described above, if the data entry field is an email entry data entry field, the system may determine if the data representing a user email is less than a predetermined number of characters and also determines if the final four characters input by the user match a certain type of character (e.g., checks to see if the last four characters are one of “.com”, “.net”, “.org”, “.gov” etc). If both conditions are determined to be true, the system can, for example, automatically advance to a subsequent data entry field enabling input of another type of data.

The field condition may be independent of the format of the field. In some embodiments, the field condition may include predetermined data that is available for the system. For example, if the data entry field is a password field which does not impose a format condition on the password to be entered by a user, the system can automatically advance to a subsequent field by detecting the that the data input by the user in the data entry field matches a stored password data associated with that user because the system knows the user's password. Additionally, when creating a password, the user may be asked to re-enter the password in a further data entry field to “confirm password”. In this embodiment, for example, the data entry field enabling initial entry of the password and the data entry field enabling confirmation of the password may be linked such that the system can automatically advance to further data entry fields after comparing the data entered in the confirmation data entry field with the data entered in the initial data entry field. In this example, the system can detect completion of the “confirm password” entry based on the first entry of the password.

The following is a further description of example data entry field types and their associated field condition data that would result in execution of a function, such as the automatic advancement to a subsequent field. It should be noted that these examples are intended for purposes of illustrating various embodiments and should not be viewed as the exclusive types of field and/or field condition data that may exist. A skilled person would understand that any type of field able to receive data from a user from within a user interface may be used and any manner of field condition data may be associated with that field. In some embodiments, the field information 800 may include a user name data that requires the user to enter their user name associated with their user profile. For example, the user name may be an email address and the field condition data associated with the user name field may include information representing an email address.

The field information 800 may include field relationship data that identifies prior and subsequent fields that surround the particular data entry field. For example, field information 800 may include “Relationship prior” data 810 identifying a prior data entry field and “Relationship_subsequent” data 812 identifying a next data entry field to advance to in response to field condition data 808 being satisfied. The relationship data 810 and 812 may be used by the system to aid in the automatic advancement and navigation between data entry fields whereby upon satisfaction of field condition data of the particular data entry field, the system uses the “relationship_subsequent” data 812 to determine and identify a next field in which user entry of data is to be enabled. Additionally, in response to a “back” command entered by a user during the process of entering data in the particular data entry field, the system may automatically revert to a prior data entry field and allow data that had previously been entered into the prior field to be modified using the “relationship_prior” data associated with particular data entry field. This is particularly advantageous in the event that a user realizes that data entered into a prior field that satisfies the field condition data of that field is nonetheless incorrect. Knowing the immediately prior data entry field allows the UI generator to ensure that the user can correct any errors.

Table 1 includes a listing of different types data entry fields that may be included in one or more user interface display images. Table 1 also provides example field condition information that must be satisfied in order to execute a function, such as automatic advancement to a subsequent data entry field.

TABLE 1
Data entry fields and Conditions

| | Data entry field | |
|---|---|---|
| Data entry field Type | Description | Example Condition |
| User name | Enables entry of a user | Requires valid email |
| | name | address; last four characters |
| | | entered are from a valid |
| | | domain (e.g..com, .net, .org, |
| | | .gov etc) |
| Street Address | Enables entry of user | Last two characters match |
| | street address | predetermined type of street |
| | | (e.g. st, rd, dr, pl) |
| State | Selects the user's state | Compares entered two |
| | | character state abbreviation |
| | | with known abbreviations |
| Zip code | Enable entry of user zip | Input must have 5 |
| | code | characters, compares to |
| | | prestored list of known zip |
| | | codes |
| Time | Enables entry of | Format must be HH:MM |
| | timestamp data | |
| Data | Enable entry of date | Format must be |
| | | DD/MM/YYYY or |
| | | MM/DD/YYYY |
| User Characteristic | Identifies user as male | Data must be M or F |
| | or female | |

The above described data entry fields and conditions are provided for purposes of example only and the system is not limited to these fields and respective conditions. Additionally, the system is also not limited to the conditions for the fields shown above. Rather, persons skilled in the art would understand how to define field conditions for respective fields depending on the type of data that is being requested via the user interface.

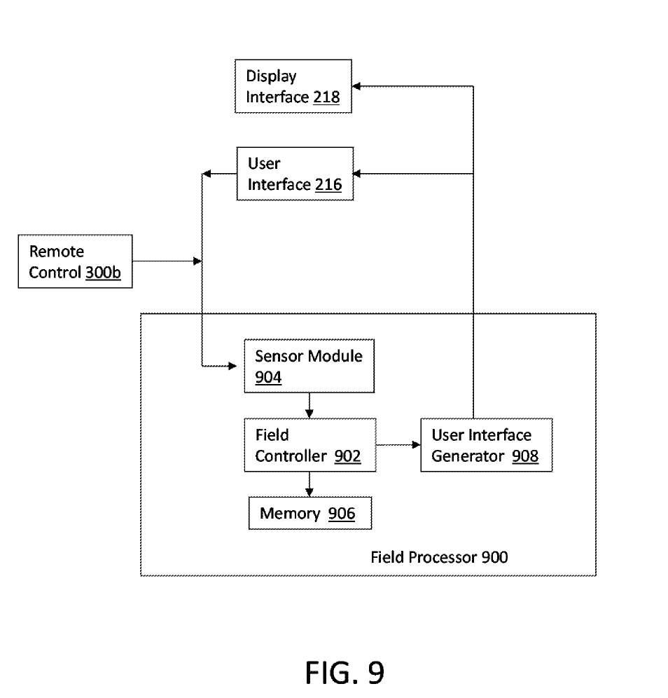

FIG. 9 is a block diagram of an example computing system including processors and/or modules that implement various embodiments. A field processor 900 selectively receives and analyzes data input into various data entry fields in a user interface display image to determine if the type of data input by the user is correct resulting in the automatic advancement from the most recently completed data entry field to a subsequent data entry field. Despite the field processor 900 being shown as a distinct component, the field processor 900 may also be embodied as part of the controller 214 in FIG. 2. In some embodiments, the field processor 900 may be a dedicated processor that is electrically coupled to the controller 214 in FIG. 2 as well as to other elements of FIG. 2 as will be discussed hereinbelow. Thus, while in a first embodiment the field processor 900 may be included as part of receiving device 200 in FIG. 2, the field processor 900 may, in some embodiments, be a standalone circuit included in any electronic device able to generate user interface display images including at least one data entry field that receives input data from a user.

The field processor 900 includes a field controller 902. The field controller 902 includes all necessary computer implemented instructions to determine field conditions associated with respective data entry fields and analyze data input by a user within the respective data entry field to determine if the input data matches the field conditions associated with the respective data entry field. The field controller 902 is coupled to a memory 906 in which is stored field information data describing the various types of data entry fields that may be included within different user interfaces as well as field condition data associated with each data entry field. The information stored in memory 906 which is accessible by field controller 902 may include any of the field information described above with respect to FIG. 8.

A user interface (UI) generator 908 is controlled to generate user interface display images including at least one data entry field for receiving input data from a user. The field controller 902 executes instructions for generating a user interface display image enabling a user to input data therein. These instructions may include, for example, generation of a series of different user interface display images each including different types of data entry fields that enable users to enter different types of data therein. Based on these instructions, the field controller 902 controls the UI generator 908 to generate a UI display image including at least one data entry field stored in memory 906. The UI generates the display image and outputs the generated user interface display image including at least one data entry field enabling user entry of data to at least one of the display interface 218 for display on display device 114 (FIG. 1); the user interface for output to the user input device 300b (FIG. 3B); and a touch panel interface for output to a touch sensitive display device 300a (FIG. 3A). From these different interfaces, a user may view and interact with the data entry fields in the UI using various input devices. In one embodiment, when the UI is displayed on a display device via the display interface 218, the user may employ remote control 300b and enter data into a respective data entry field by using navigation buttons and/or alphanumeric keys of the remote control 300b. In some embodiments, if the display device 114 is a touch sensitive display device, a user may select a data entry field by touching a position on the screen associated with the data entry field and entering the data using one of a gesture based input and/or a virtual keyboard that is also selectively displayed either within the UI or overlaid on the UI. This manner of inputting data into data entry fields may also be applicable if the device on which the UI is output is a touch sensitive display device 300a. The following discussion refers to the general process of inputting data into a data entry field within a UI. However, this is described generically to illustrate various embodiments and any manner of inputting data into a data entry field may be implemented.

A sensor module 904 is coupled to the field controller 902 and senses signals representing a respective data entry field selected by the user and the data being input into the selected data entry field. The sensor module 904 processes the input signal to identify the data entry field selected by the user and senses the data being input by the user. The sensor module 904 provides the information identifying the data entry field and the data input by the user within the identified field to the field controller 902. The field controller 902 queries the field information in the memory 906 to determine the field conditions associated with the selected data entry field and compares at least a portion of the data input by the user to determine if the input data matches the field conditions associated with that field. In response to determining that the input data matches the field conditions, the field processor 902 controls the UI generator to modify the UI to automatically advance to a subsequent field within the UI enabling input of a subsequent data. In another embodiment, in response to determining the input data matches the field condition, the field controller 902 may control the UI generator 908 to generate subsequent display images including additional data entry fields enabling subsequent user input of data.

In another embodiment, the field controller 902 may control the UI generator 908 to provide visual feedback upon determining that the data input into a respective data entry field matches the associated field condition. This may include modification of a characteristic of one of the data entry field in which the data is being entered and a characteristic of the UI in which the data entry field appears. For example, this visual feedback may include changing a color of one of an icon associated with the data entry field and the text displayed within the data entry field. In another embodiment, the field controller 902 may cause the data entry field to be inaccessible thereby preventing further entry of information therein in response to determining that the input data matches the field conditions of the field. This may be illustrated by fading out the field and/or text within the field.

In another embodiment, the field controller 902 may delay transitioning to subsequent data entry field and/or subsequent UI display image including subsequent data entry fields for a predetermined time after determining that the input data matches the field conditions. During the delay, the field controller 902 may control the UI generator to generate and present, to a user, a visual cue (e.g., fading out of current screen and fading in of next screen) indicating that system has detected completion and will go to next field/screen/GUI unless a user indicates data entry is not completed (e.g., by pressing a particular button on the remote while the transition effect is occurring, or making a swipe gesture on touch sensitive input device such as a tablet or mobile phone).

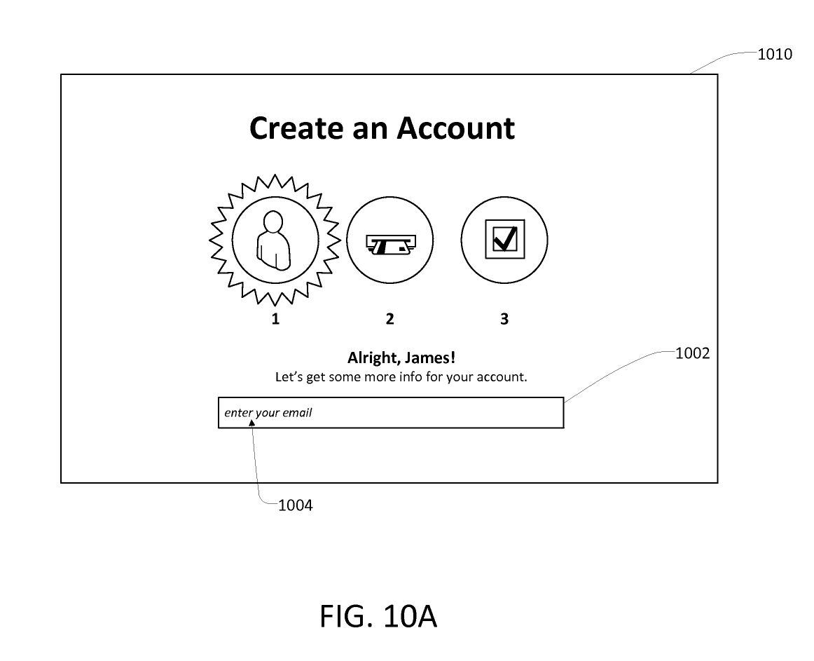

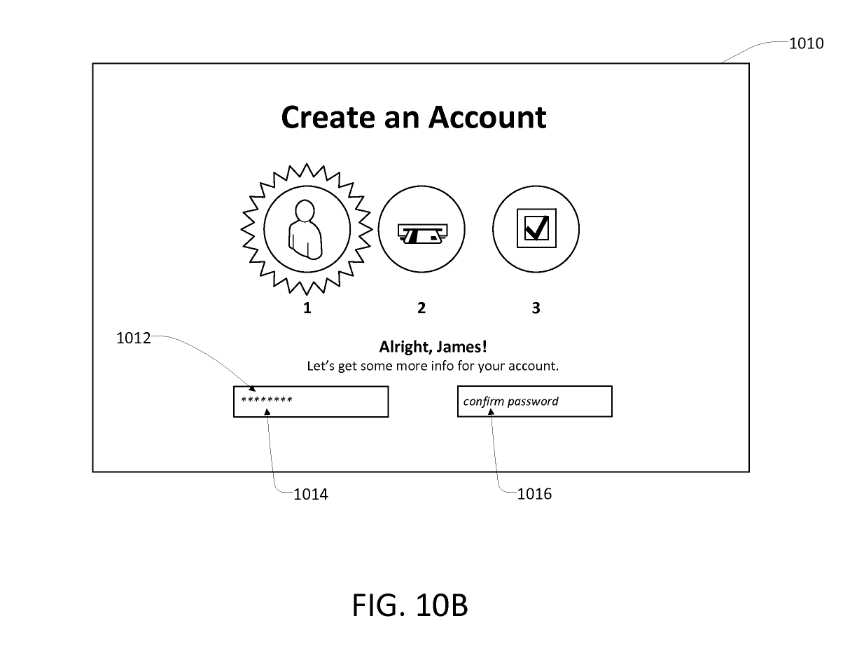

FIGS. 10A and 10B illustrate example user interface display images generated by the UI generator 908 in FIG. 9. The example user interface display images shown herein illustrate the operational principles of the automatic data entry field advancement technique described herein. The user interfaces shown in FIGS. 10A and 10B represent various user interfaces generated during an account creation routine executed by controller 214 in FIG. 2 The field controller 902 uses the account creation algorithm executed by controller 214 to control the UI generator 908 to generate respective user interface display images that are intended to elicit information from a user to be used in registering the user for an account with the system. Field controller 902 causes UI generator 908 to generate a first UI display image 1000 intended to elicit information identifying an email address of a user. The field description describing the type of data to be entered in the first data entry field is also shown as field description data 1004. The first UI display image 1000 includes a first data entry field 1002. A user may use an input device (e.g. remote control and/or touch panel) to select the first data entry field 1002 as the active field in which data is to be entered. The user may further use the input device to enter input data representative of the user's email address in the first data entry field 1002. The sensor module 904, in real time, senses the input signals representing user input data and provides them to the field controller 902 which compares the received input data to field conditions associated with the first data entry field. In this embodiment, the field conditions associated with the first data entry field is the inclusion of the final four characters input by the user being one of, but not limited to, .com, .net, .org, and .gov. Because all email addresses end in the domain suffix, the system will intelligently know when the input of data has been completed. Once completed, the field controller 902 causes the UI generator 908 to generate a subsequent UI display image shown in FIG. 10B. The subsequent UI display image 1010 shown in FIG. 10B includes a subsequent data entry field enabling input of subsequent data therein.

The UI display image 1010 in FIG. 10B includes a subsequent data entry field 1012 enabling a user to enter subsequent data therein. The subsequent data entry field 1012 also includes field description information 1014 informing the user of the type of information to be entered into the subsequent data entry field. As this field is requesting an entry of a password for the first time, the automatic advancement feature may not be available. The user may enter password data in the subsequent data entry field 1012 and input a “proceed” command (e.g. hit enter, select an icon, input a specific gesture on a touch sensitive display device) to provide the password data to the system. However, the display image 1010 also includes a further data entry field 1016 in which the user is requested to re-enter the password data input in field 1012. In response to inputting password confirmation data in data entry field 1016, the sensor module 904 senses the input signals and provides the sensed data to the field processor 902 which compares the password confirmation data entered into field 1016 with the password information entered via data entry field 1012 to determine if they match. In response to detecting that the data values from data entry field 1012 and data entry field 1016 match, the field processor 902 controls the UI generator to generate further UI display images including further data entry fields intended to elicit information from the user for the account creation process.

It is important to note that this is merely one example implementation of the system according to various embodiments and should be construed as limiting the principles to this single embodiment. Any series of user interfaces including any number of data entry fields designed to elicit information from a user for any purpose may be used.

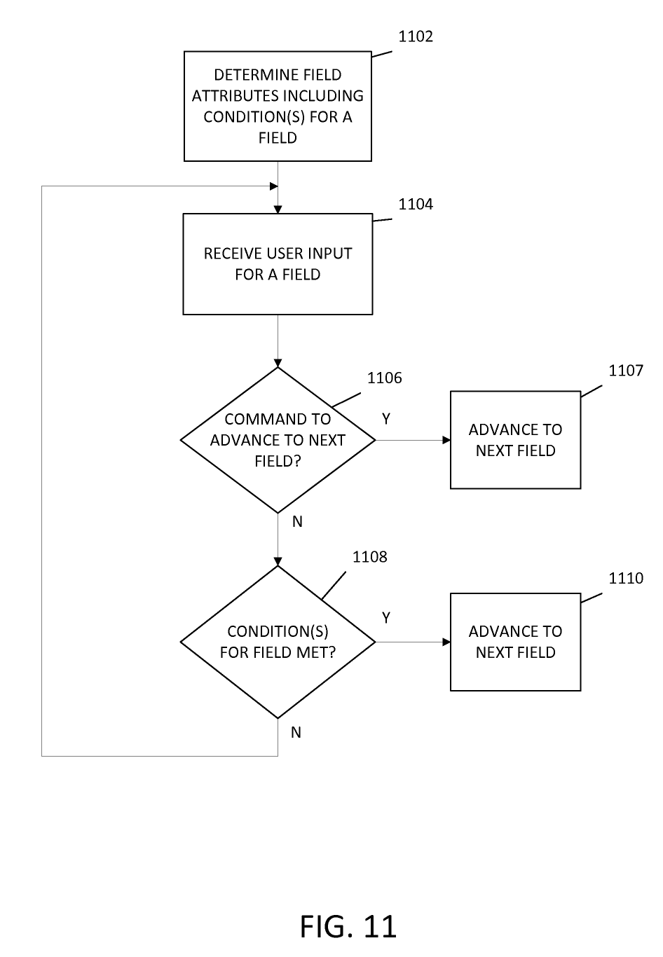

FIG. 11 illustrates an example method for implementing the system according to various embodiments. The field processor 902 determines (1102) attributes including field conditions that are associated with a respective data entry field that enables a user to input data therein. The sensor module 904 receives (1104) user input data in a respective data entry field. The field controller 902 queries (1106) whether or not an advance command directing the system to advance to a subsequent data entry field has been received. At 1104, if the result of the query is positive, then the system advances (1107) to the next field. If the result of the query is negative, the field controller 902 queries (1108) if the field condition has been satisfied by determining if the data input by the user matches the field condition. In response to determining that the data input by the user matches the field condition, the system automatically advances (1110) to a subsequent data entry field enabling input of subsequent data by the user. At 1106, if the result of the query is negative, the process proceeds to 1104 to determine if additional data is being input by the user that will satisfy the field conditions.

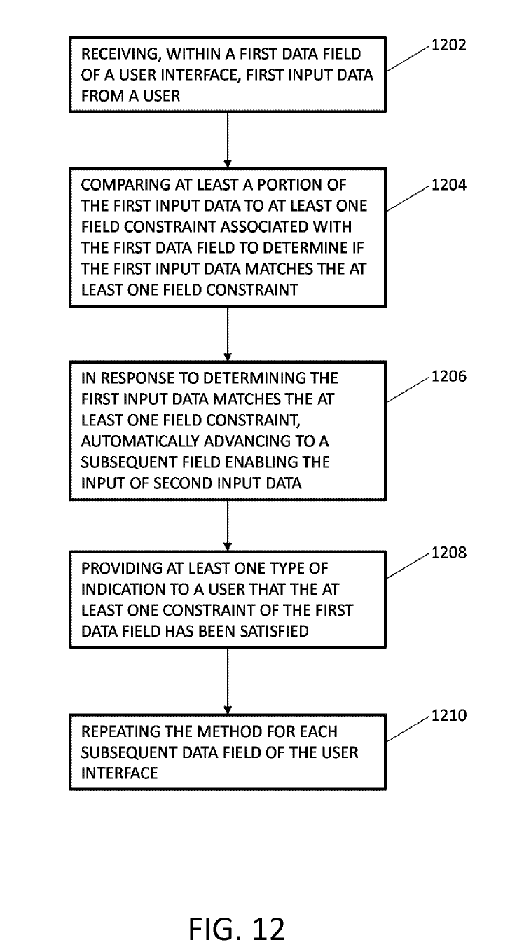

FIG. 12 illustrates another example method for implementing various embodiments. The method of FIG. 12 provides a method of entering data into data entry fields of a user interface. First input data from a user is received (1202) within a first data entry field of a user interface. A controller compares (1204) at least a portion of the first input data to at least one field condition associated with the first data entry field to determine if the first input data matches the at least one field condition. The at least one field condition may include at least one of a predetermined number of alphanumeric characters, a predetermined type of data, a type of data selected from a candidate set of types of data, a type of data associated with a user profile, a predetermined order of alphanumeric characters, a combination of a predetermined type of alphanumeric characters and symbol characters, and data describing a characteristic of a user. Additionally, the at least one field condition includes relationship information identifying a subsequent data entry field thereby advantageously mapping which of the data entry fields in the UI display image is to be considered the subsequent data entry field.

In one embodiment, when the controller compares the input data to the field condition data, the controller determines if the first input data is entered in a predetermined format defined by the at least one field condition associated with the first data entry field.

In response to determining the first input data matches the at least one field condition, automatically advances (1206) to a subsequent field enabling the input of second input data. In one embodiment, the controller may delay the automatic advancement to the second data entry field for a predetermined period of time after determining the portion of the first input data matches the at least one field condition. In doing so, the controller may cause the UI generator to provide a visual cue that the at least one condition associated with the first data entry field has been satisfied during the delay prior to automatically advancing to the second data entry field.

The user is provided (1208) with at least one type of indication that the at least one condition has been satisfied, and the method is repeated (1210) for each data entry field in the user interface. The at least one type of indication may be a visual indication and/or an audible indication. In one embodiment, the at least one type of indication includes modifying a characteristic of at least one of the first data entry field and an indicator associated with the first data entry field. The modification of a characteristic may include changing a color of the at least one of the first data entry field, the first input data within the first data entry field, a background of the first data entry field, an indicator associated with the first data entry field, and a characteristic of the first data entry field.

Although embodiments which incorporate the teachings of the present disclosure have been shown and described in detail herein, those skilled in the art can readily devise many other varied embodiments that still incorporate these teachings. Having described preferred embodiments of a system, method and user interface for content search (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A computing system comprising:
one or more processors; and
a memory storing instructions executable by the one or more processors to perform a method comprising:
obtaining a first set of one or more characters input in a data entry field;
obtaining a first determination, the first determination including a determination of whether the first set satisfies a non-number condition; and
executing the function of the computing system based on the first determination if the first set satisfies the non-number condition, wherein the function is not executed based on the first determination if the first set does not satisfy the non-number condition.

2. The computing system of claim 1, the method further comprising:
obtaining a second determination, the second determination including a determination of whether the first set satisfies a number condition, wherein executing the function based on the first determination is further based on the second determination, such that the function is executed if the first set also satisfies the number condition, and the function is not executed based on the first and second determinations if the first set does not satisfy either the first determination or the second determination.

3. The computing system of claim 2, the method further comprising:
obtaining a second set of two or more characters input in the data entry field, the second set including the first set and one or more additional characters;
obtaining a third determination, the third determination including a determination of whether the second set satisfies the non-number condition; and
executing the function of the computing system based on the third determination if the second set satisfies the non-number condition, wherein the function is not executed based on the third determination if the second set does not satisfy the non-number condition.

4. The computing system of claim 2, wherein the number condition includes a condition that a number of characters in the first set is greater than a predetermined number, the predetermined number being two or more.

5. The computing system of claim 1, the method further comprising:
obtaining a second set of two or more characters input in the data entry field, the second set including the first set and one or more additional characters;
obtaining a second determination, the second determination including a determination of whether the second set satisfies the non-number condition; and
executing the function of the computing system based on the second determination if the second set satisfies the non-number condition, wherein the function is not executed based on the second determination if the second set does not satisfy the non-number condition.

6. The computing system of claim 1, wherein the function includes a search based on the first set.

7. The computing system of claim 1, wherein obtaining the first determination includes comparing at least a portion of the first set to at least one field condition associated with the data entry field to determine if the first set matches the at least one field condition.

8. The computing system of claim 1, wherein the function includes advancing to a subsequent data entry field.

9. The computing system of claim 8, the method further comprising:
delaying the advancing to the subsequent data entry field for a predetermined period of time.

10. The computing system of claim 9, the method further comprising:
providing an indication to a user during the delay, the indication indicating that advancing to the subsequent data entry field will be performed.

11. The computing system of claim 1, wherein the non-number condition includes that the first set is in a predetermined format defined by at least one field condition associated with the data entry field.

12. The computing system of claim 11, wherein the at least one field condition includes at least a predetermined number of alphanumeric characters, a predetermined type of data, a type of data selected from a candidate set of types of data, a type of data associated with a user profile, a predetermined order of alphanumeric characters, a combination of a predetermined type of alphanumeric characters and symbol characters, or data describing a characteristic of a user.

13. The computing system of claim 1, the method further comprising:
providing at least one indication to a user in response to the execution of the function.

14. The computing system of claim 13, wherein providing the at least one indication includes modifying a characteristic of at least the first data entry field or an indicator associated with the first data entry field.

15. A non-transitory computer-readable medium storing computer-executable instructions executable to perform a method comprising:
obtaining a first set of one or more characters input in a data entry field;
obtaining a first determination, the first determination including a determination of whether the first set satisfies a non-number condition; and
executing the function of the computing system based on the first determination if the first set satisfies the non-number condition, wherein the function is not executed based on the first determination if the first set does not satisfy the non-number condition.

16. The non-transitory computer-readable medium of claim 15, the method further comprising:
obtaining a second determination, the second determination including a determination of whether the first set satisfies a number condition, wherein executing the function based on the first determination is further based on the second determination, such that the function is executed if the first set also satisfies the number condition, and the function is not executed based on the first and second determinations if the first set does not satisfy either the first determination or the second determination.

17. The non-transitory computer-readable medium of claim 16, the method further comprising:
obtaining a second set of two or more characters input in the data entry field, the second set including the first set and one or more additional characters;
obtaining a third determination, the third determination including a determination of whether the second set satisfies the non-number condition; and
executing the function of the computing system based on the third determination if the second set satisfies the non-number condition, wherein the function is not executed based on the third determination if the second set does not satisfy the non-number condition.

18. The non-transitory computer-readable medium of claim 16, wherein the number condition includes a condition that a number of characters in the first set is greater than a predetermined number, the predetermined number being two or more.

19. The non-transitory computer-readable medium of claim 15, the method further comprising:
obtaining a second set of two or more characters input in the data entry field, the second set including the first set and one or more additional characters;
obtaining a second determination, the second determination including a determination of whether the second set satisfies the non-number condition; and
executing the function of the computing system based on the second determination if the second set satisfies the non-number condition, wherein the function is not executed based on the second determination if the second set does not satisfy the non-number condition.

20. The non-transitory computer-readable medium of claim 15, wherein the function includes a search based on the first set.

21. The non-transitory computer-readable medium of claim 15, wherein obtaining the first determination includes comparing at least a portion of the first set to at least one field condition associated with the data entry field to determine if the first set matches the at least one field condition.

22. The non-transitory computer-readable medium of claim 15, wherein the function includes advancing to a subsequent data entry field.

23. The non-transitory computer-readable medium of claim 22, the method further comprising:
delaying the advancing to the subsequent data entry field for a predetermined period of time.

24. The non-transitory computer-readable medium of claim 23, the method further comprising:
providing an indication to a user during the delay, the indication indicating that advancing to the subsequent data entry field will be performed.

25. The non-transitory computer-readable medium of claim 15, wherein the non-number condition includes that the first set is in a predetermined format defined by at least one field condition associated with the data entry field.

26. The non-transitory computer-readable medium of claim 25, wherein the at least one field condition includes at least a predetermined number of alphanumeric characters, a predetermined type of data, a type of data selected from a candidate set of types of data, a type of data associated with a user profile, a predetermined order of alphanumeric characters, a combination of a predetermined type of alphanumeric characters and symbol characters, or data describing a characteristic of a user.

27. The non-transitory computer-readable medium of claim 15, the method further comprising:
providing at least one indication to a user in response to the execution of the function.

28. The non-transitory computer-readable medium of claim 27, wherein providing the at least one indication includes modifying a characteristic of at least the first data entry field or an indicator associated with the first data entry field.

29. A method of executing a function of a computing system, the method comprising:
obtaining a first set of one or more characters input in a data entry field;
obtaining a first determination, the first determination including a determination of whether the first set satisfies a non-number condition; and
executing the function of the computing system based on the first determination if the first set satisfies the non-number condition, wherein the function is not executed based on the first determination if the first set does not satisfy the non-number condition.

30. The method of claim 29, further comprising:
obtaining a second determination, the second determination including a determination of whether the first set satisfies a number condition, wherein executing the function based on the first determination is further based on the second determination, such that the function is executed if the first set also satisfies the number condition, and the function is not executed based on the first and second determinations if the first set does not satisfy either the first determination or the second determination.

31. The method of claim 30, further comprising:
obtaining a second set of two or more characters input in the data entry field, the second set including the first set and one or more additional characters;
obtaining a third determination, the third determination including a determination of whether the second set satisfies the non-number condition; and
executing the function of the computing system based on the third determination if the second set satisfies the non-number condition, wherein the function is not executed based on the third determination if the second set does not satisfy the non-number condition.

32. The method of claim 30, wherein the number condition includes a condition that a number of characters in the first set is greater than a predetermined number, the predetermined number being two or more.

33. The method of claim 29, further comprising:
obtaining a second set of two or more characters input in the data entry field, the second set including the first set and one or more additional characters;
obtaining a second determination, the second determination including a determination of whether the second set satisfies the non-number condition; and
executing the function of the computing system based on the second determination if the second set satisfies the non-number condition, wherein the function is not executed based on the second determination if the second set does not satisfy the non-number condition.

34. The method of claim 29, wherein the function includes a search based on the first set.

35. The method of claim 29, wherein obtaining the first determination includes comparing at least a portion of the first set to at least one field condition associated with the data entry field to determine if the first set matches the at least one field condition.

36. The method of claim 29, wherein the function includes advancing to a subsequent data entry field.

37. The method of claim 36, further comprising:
delaying the advancing to the subsequent data entry field for a predetermined period of time.

38. The method of claim 37, further comprising:
providing an indication to a user during the delay, the indication indicating that advancing to the subsequent data entry field will be performed.

39. The method of claim 29, wherein the non-number condition includes that the first set is in a predetermined format defined by at least one field condition associated with the data entry field.

40. The method of claim 39, wherein the at least one field condition includes at least a predetermined number of alphanumeric characters, a predetermined type of data, a type of data selected from a candidate set of types of data, a type of data associated with a user profile, a predetermined order of alphanumeric characters, a combination of a predetermined type of alphanumeric characters and symbol characters, or data describing a characteristic of a user.

41. The method of claim 29, further comprising:
providing at least one indication to a user in response to the execution of the function.

42. The method of claim 41, wherein providing the at least one indication includes modifying a characteristic of at least the first data entry field or an indicator associated with the first data entry field.
